(19) United States
(12) Patent Application Publication
(10) Pub. No.: US 2005/0247239 A1
(43) Pub. Date: Nov. 10, 2005

(54) Adjustable height casegood and desk

(76) Inventors: Thomas J. Newhouse, Grand Rapids, MI (US); Douglas J. Hill, Grand Rapids, MI (US); S. Michael Crump, Grandville, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/838,717

(22) Filed: May 4, 2004

(51) Int. Cl. A47B 37/00; E05B 65/46

(52) U.S. Cl. 108/50.01

(57) ABSTRACT

A casegood such as a pedestal desk or credenza is provided with a height adjustment mechanism. The height adjustment mechanism is attached to an outer wall of the casegood. By rotating the height adjustment mechanism, the distance of the casegood's work surface from the floor can be adjusted so as to provide an ergonomic and efficient work area.

### BACKGROUND OF THE INVENTION

The present invention relates to casegoods such as furniture for an office. More specifically, the field of the invention involves casegoods having adjustable height mechanisms.

Modern casegoods allow flexible arrangement of an office or other room and facilitate the connection of office equipment such as telephones, computers, monitors and printers. Typically, a casegood is composed of work surfaces, cabinets, panels and drawers.

One critical factor for an ergonomic casegood is the height of the work surfaces. The position of the hands, feet, torso, and legs of a person are dependent upon the height of the work surface. If the work surface height is not appropriate, a person could experience inconvenience and discomfort. In extreme cases, a person may even suffer injury from repetitively using a work surface at the wrong height.

Ideally, the height of the work surface should be varied dependent upon the height of the person using the casegood. For example, a person of a height of about five feet should have a work surface approximately 26 inches from the floor while a person of a height of about six feet should have a work surface approximately 29 inches from the floor. Drawers at an appropriate height relative to the work surface should also be available to someone using the work surface.

Variable height tables, such as those shown U.S. Pat. No. 5,549,053, issued to John E. Grout, U.S. Pat. No. 6,312,069, issued to Teng-Tsai Wang and U.S. Pat. No. 5,598,788, issued to Kurt A. Jonker have been developed. However, none show an adjustable height casegood or an adjustable height table with attached drawers where the height of the drawers is adjustable as well. If the height of the drawers associated with the work surface do not move, an awkward working arrangement is created between a relatively high work surface and relatively low drawers.

A casegood providing for adjustable height both of the work surface and attached drawers is thus highly desirable.

### SUMMARY OF THE INVENTION

The aforementioned problems are overcome in the present invention. The casegood is provided with vertical walls. The work surface of the casegood is positioned on top of the walls. Height adjustment mechanisms are attached to the exterior of the vertical walls. By raising and lowering the vertical walls, the height of the work surface is also adjusted. Drawers or cabinets attached to the sidewalls and the work surface are also raised or lowered at the same time as the work surface. The height of all components of the casegood are at the same relative height, allowing for ease of use of the entire casegood.

To allow ease of adjustment of the height, the height adjustment mechanism is attached to the exterior portion of the sidewall. The mechanism is enclosed within a removable cover so as not to detract from the appearance of the casegood. If the mechanism needs servicing, the cover is removed.

The adjustable height mechanism itself is composed of a leg with a threaded portion. The threaded portion inserted within an internally threaded cylinder. The internally threaded cylinder is attached to a bracket and the bracket is attached to the casegood sidewall. By rotating the legs of the various mechanisms attached to the casegood, the entire casegood may be either raised or lowered. The lower portion of the leg is marked with measurements indicating the distance of the work surface from the floor, thereby facilitating the alignment of the height of the casegood.

The casegood work surface is arranged to cover the tops of the height adjustment mechanism. Apertures are provided within the work surface for access to the well containing the height adjustment mechanism. At the top of the bracket is located a collar. An attachment such as cabinetry or screens can be placed on the top of casegood by inserting stanchions affixed to the attachment into the collar. When a select number of stanchions are properly affixed within the collars, the attachment is firmly held in position on the casegood.

When stanchions are not in place within the apertures, operculums may be used. The operculum covers an aperture when no stanchion is inserted into the collar. The operculum is provided with grommets so that cabling or wiring can be extended through the operculum and the aperture and into the well. The work surface will thus be kept generally free from wires or cables.

The casegood could also be provided with a sit-to-stand desk. The height of the sit-to-stand desk can be adjusted in two different ways. First, the sit-to-stand desk is provided with a torsion mechanism for raising or lowering the work surface. Second, a slide mechanism located at the base of the sit-to-stand desk can adjust the height of the desk.

These and other objects, advantages and features of the invention will be more readily understood and appreciated by reference to the detailed description of the drawings.

### BRIEF DESCRIPTION OF THE DRAWINGS

FIG. 1 is a perspective view of the casegood.

FIG. 2 is a side view of the casegood.

FIG. 3 shows the height adjustment mechanism for the casegood.

FIG. 4 is a top plan view of the height adjustment mechanism.

FIG. 5 shows the casegoods with one drawer opened.

FIG. 6 shows a chart located within the drawer.

FIG. 7 is a perspective view of a casegood with a sit-to-stand desk.

FIG. 8 is a perspective view of a sit-to-stand desk.

FIG. 9 is a perspective view of a casegood with an attached privacy screen.

FIG. 10 is a side view of the attached privacy screen.

FIG. 11 is an overhead plan view of an aperture located on the top work surface of the casegood.

### DETAILED DESCRIPTION OF THE DRAWINGS

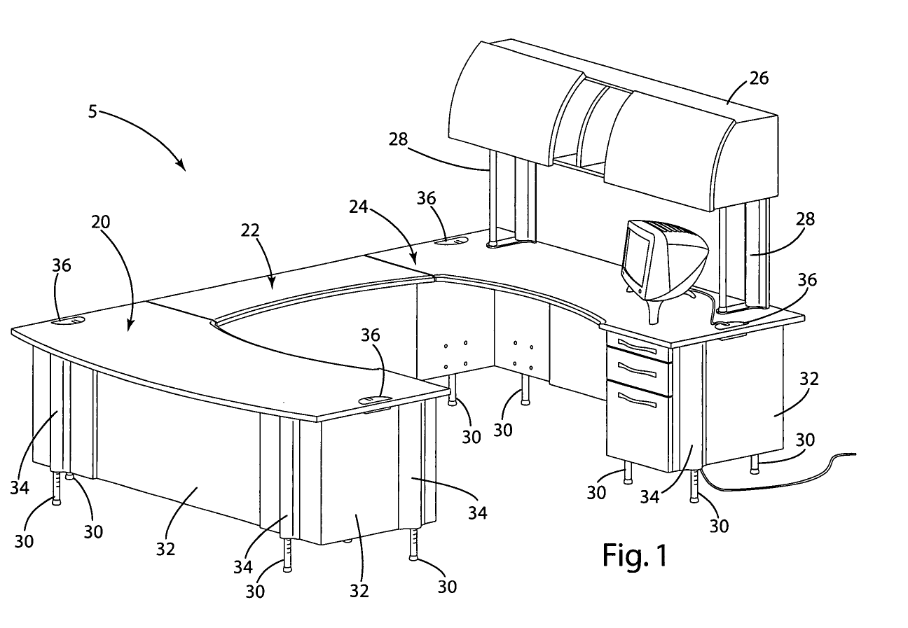

FIG. 1 shows casegood 5. Casegood 5 includes pedestal desk 20, bridge 22, and pedestal credenza 24. Overhead cabinets 26 are held up by stanchions 28. Pedestal credenza 24 includes a plurality of drawers as does pedestal desk 20.

Pedestal desk 20, bridge 22 and pedestal credenza 24 are supported by legs 30. Pedestal desk 20 has a plurality of vertical walls. Collectively, the vertical walls define a frame. The desk has an interior and an exterior. The vertical walls have exterior vertical surfaces 32. Legs 30 are located on exterior vertical surfaces 32 of pedestal desk 20, bridge 22 and pedestal credenza 24. Legs 30 are substantially contained within leg enclosures 34. Semicircular apertures 36 allow for the attachment of other units. While casegood 5 is shown as a modular work station, casegood 5 could be any furniture such as a desk or cabinet.

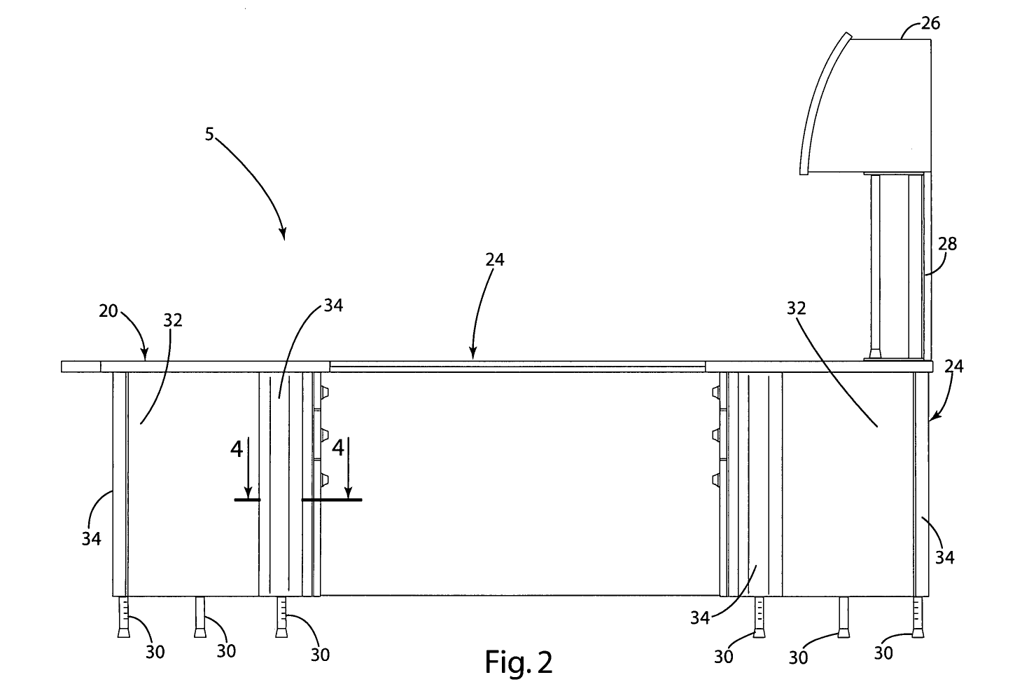

FIG. 2 is a side view of casegood 5. Leg enclosures 34 are mounted on the exterior vertical surfaces 32 of pedestal desk 20 and pedestal credenza 24.

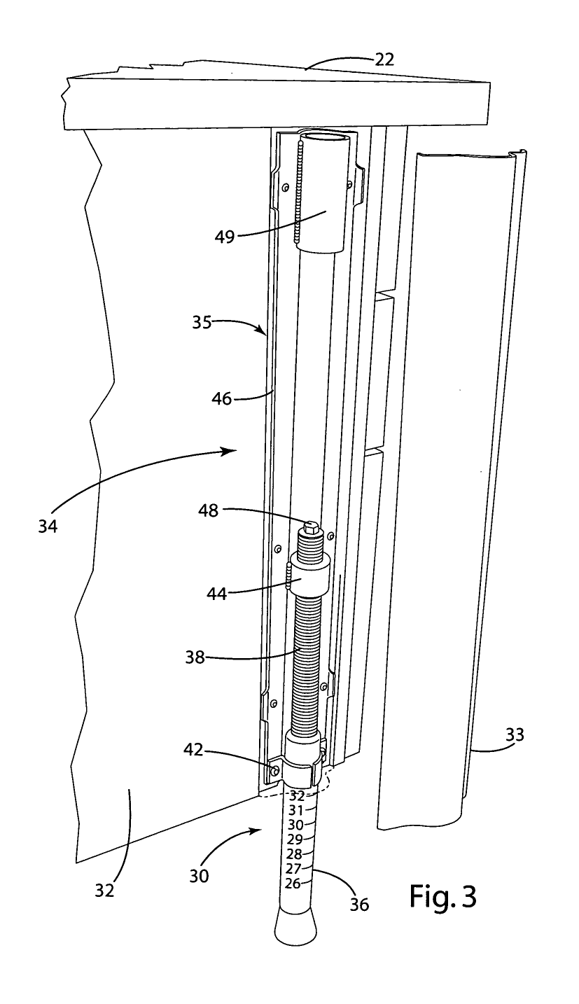

FIG. 3 shows leg 30 mounted to an exterior surface 32 of either pedestal desk 20 or pedestal credenza 24. Leg enclosure 34 includes cover 33. Cover 33 fits over a substantial portion of leg mechanism 35. Cover 33 could be solid wood profile molding or cover 33 could be veneer wrapped or powder coated aluminum extrusion or other similar/equivalent cover.

Leg 30 has lower enumerated portion 36 and threaded portion 38. Lower enumerated portion 36 is numbered from 26 to 32. Each number is separated from the previous by a space of one inch. The numbers on the enumerated portion 36 are indicative of the height of the work surface 22 above the floor. For example, if number “30” were displayed immediately below cover 33, work surface 22 would be approximately 30 inches above the floor. Obviously, the numbers on the leg could correspond to any measurement system and could be in increments other than one inch.

Leg 30 is held to leg mechanism 35 by internally threaded cylinder 44. Internally threaded cylinder 44 is attached to bracket 46. Bracket 46 is attached to outer surface 32 by a plurality of fasteners, such as screws. Threaded portion 38 of leg 30 extends through internally threaded cylinder 44. Rotation of leg 30 causes upper surface 40 to be raised or lowered.

The leg could be rotated by manipulation of the lower portion of leg 30. Alternatively, hexagonal head 48 could be provided to extend from the top of leg 30. If hexagonal head 48 were provided, cover 33 would be removed. A tool such as a wrench would be attached to hexagonal head 48. The tool would then rotate leg 30, causing work surface 22 to move either up or down, and dependent upon the direction of rotation of leg 30. The numbers on leg 30 provide an easy indicator of the height of work surface 22, facilitating the adjustment of each leg 30 of casegood 5 so that all work surfaces are level.

At the top of bracket 46 is collar 49. Collar 49 is suitable for attachment to the stanchions of any object that might be placed on work surface 22.

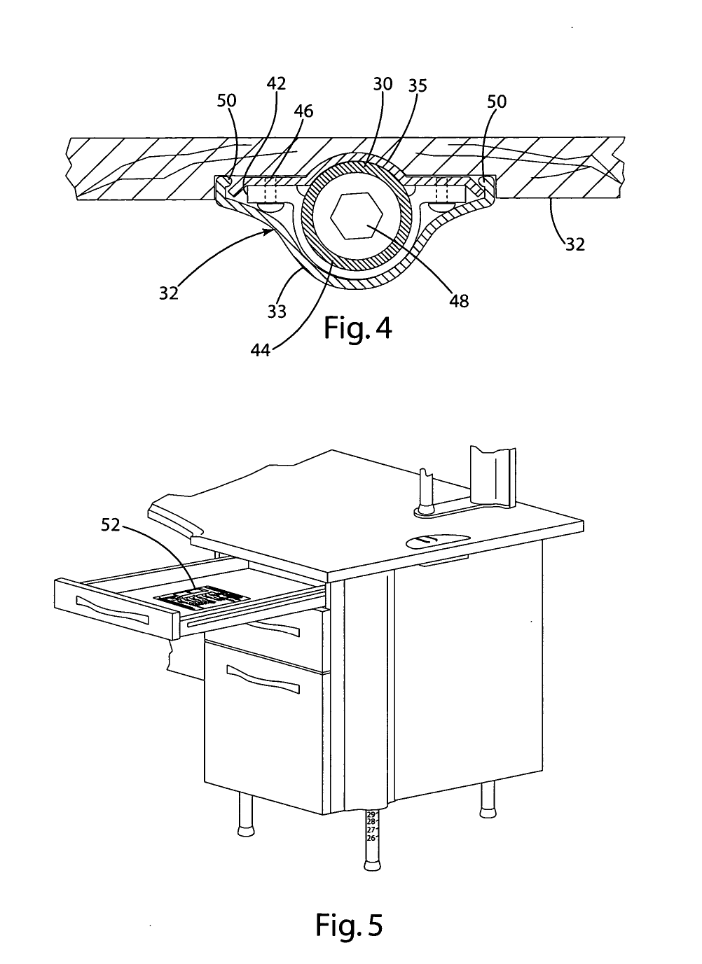

FIG. 4 shows the manner of the attachment of leg mechanism 35 to exterior wall 32. Bracket 46 is attached to a recess within exterior wall 32. Cover 33 has lips 50 engagable with bracket 46. Sufficient force on cover 33 can cause cover 33 to separate from bracket 46. After adjustment of the height of work surface 22, cover 33 can be affixed to bracket 46 by the application of force to the outside of cover 33.

Leg mechanism 35 is concealed under cover 33 providing a generally pleasing appearance, but leg mechanism 35 can be easily accessed for servicing by removing cover 33.

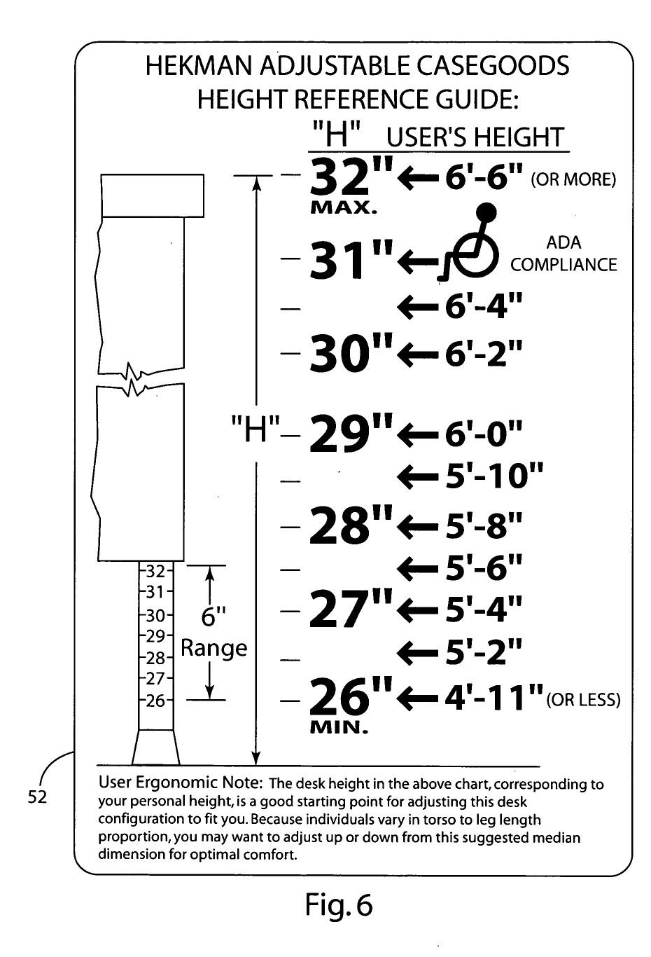

FIG. 5 shows a corner cabinet of either pedestal desk 20 or pedestal credenza 24. Affixed to the bottom of the top drawer is chart 52. Chart 52 is shown more fully in FIG. 6. Chart 52 is a reference for how to adjust the height of the work surfaces of casegood 5 based upon the height of the user of casegood 5. For example, a person of a height of 5′8″ would want the work surface adjusted to a height of about 28 inches. A picture of leg 30 is included in chart 52 showing the adjustment range of the work surfaces. The numbers on leg 30 are clearly shown in chart 52.

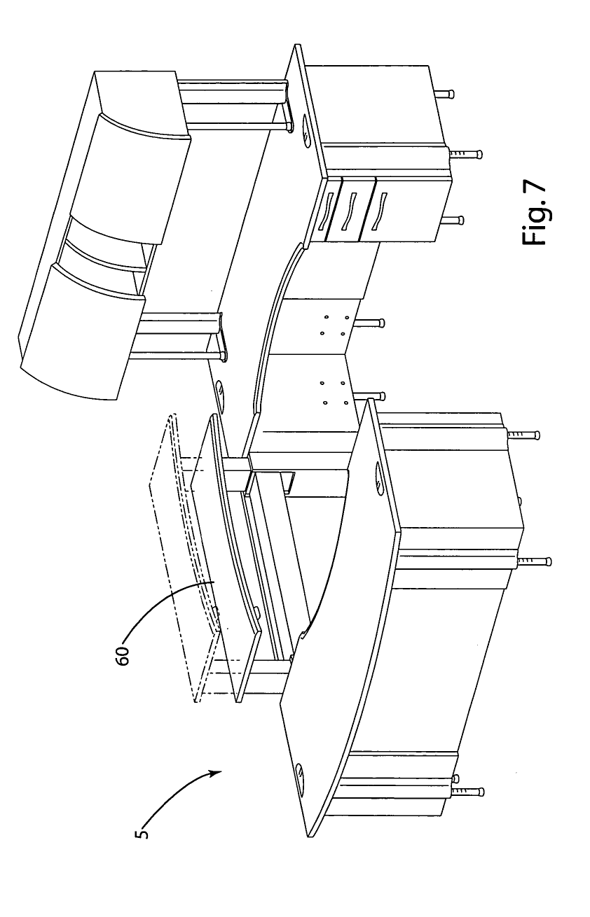

Additionally, casegood 5 could also be provided with a height adjustable sit-to-stand bridge, as shown in FIG. 7. Sit-to-stand desk 60 can be adjusted to many different heights. The work surface of sit-to-stand desk 60 could be at the same height as the work surfaces of the other components of casegood 5. Alternatively, the work surface of sit-to-stand desk 60 could be adjusted up to about eighteen inches above the work surfaces of casegood 5.

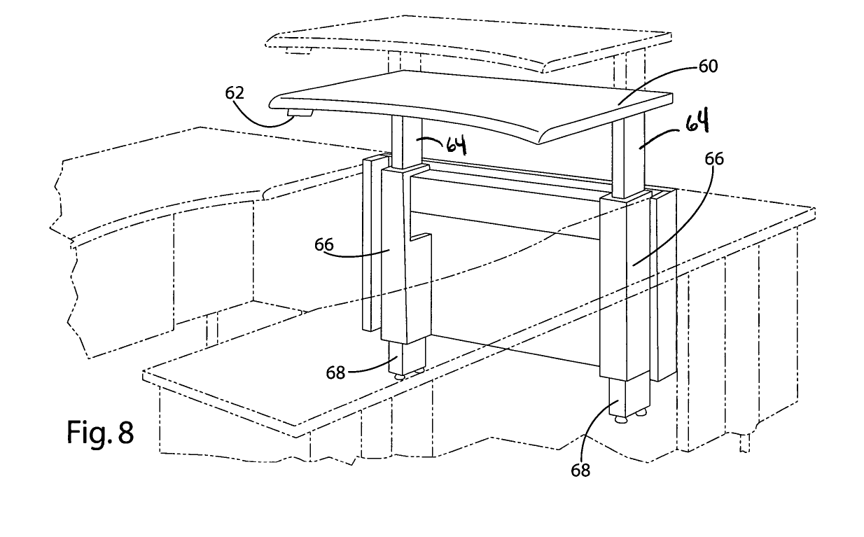

FIG. 8 shows sit-to-stand desk 60. Sit-to-stand work surface 62 is held by two rectangular cross-section supports 64. Supports 64 extend into support enclosures 66. Supports 64 are connected to a torsion mechanism contained with support enclosures 66. The torsion mechanism uses a heavy duty torsion spring contained within one of the support enclosures 66. The torsion mechanism can be locked at a desired height throughout the adjustment range of the table. The brake is activated by spring-loaded paddle 62, which is mounted on the front left hand edge of sit-to-stand desk 60. One suitable torsion mechanism is manufactured by Baker Manufacturing Company. Alternatively, the height of the sit-to-stand work surface could be adjusted by a crank or by an electric motor.

Sit-to-stand desk 60 also includes height adjustment slides 68. Height adjustment slides 68 telescope into support enclosures 66, providing an ability to adjust the height of the work surface for sit-to-stand bridge by about eighteen inches. By moving height adjustment slides 68, the work surface of sit-to-stand bridge 60 will be as the same height of the other work surfaces of casegood 5 when sit-to-stand desk 60 is at its lowest position.

The use of a sit-to-stand desk within this desk configuration minimizes the movement of a person who wishes to use the sit-to-stand desk. Rather than move out of the work area to go to a sit-to-stand desk, the sit-to-stand desk is provided in the immediate area of the user. Repositioning of work materials, books, telephone and computer is thus unnecessary.

The convenient location of the sit-to-stand desk thus encourages a user to stand during the work day.

To avoid possible injury to a user, sit-to-stand desk 60 has a gap of one inch provided on each side of sit-to-stand desk 60 between the other components of casegood 5. Sit-to-stand desk 60 could be attached to other components of casegood 5.

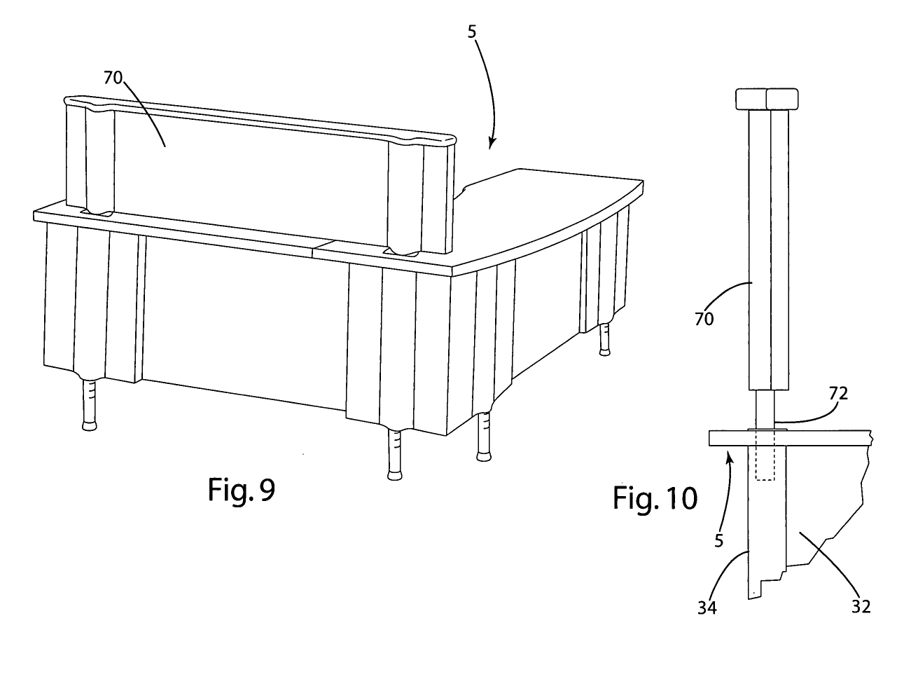

Many types of accessories such as privacy screens, transaction counters, book shelves and overhead cabinets are often desired to be added above the work surface. These accessories are usually supported by the work surface. FIG. 9 shows casegood 5 with privacy screen 70. Various attachments could be used instead of privacy screen 70. FIG. 10 shows a side view of privacy screen 70 attached to casegood 5. Stanchion 72 extends through the work surface and into the area between enclosure 34 and sidewall 32.

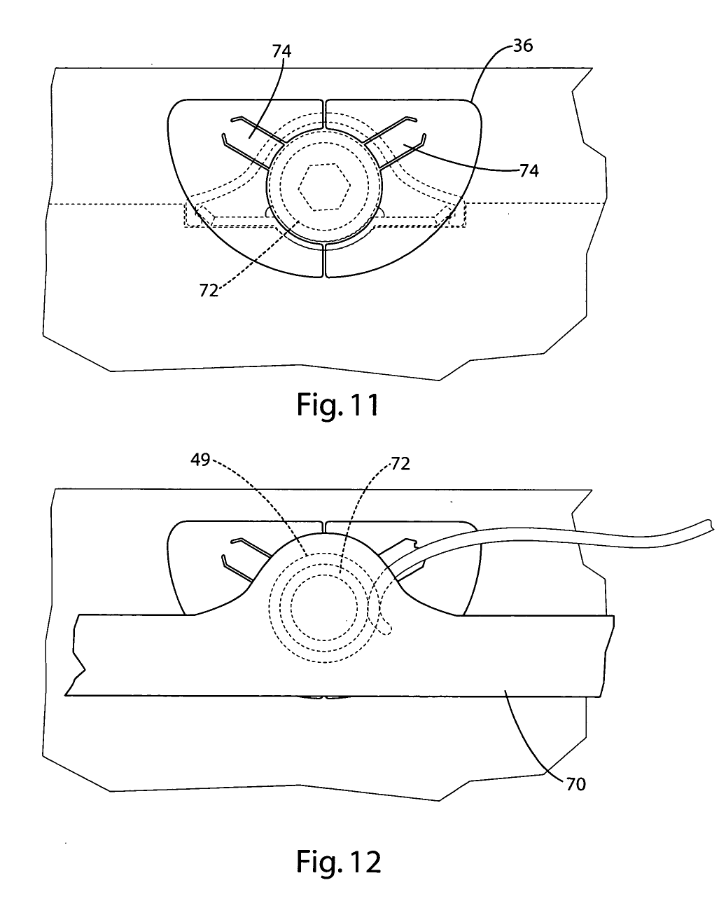

Referring once again to FIG. 1 to accommodate accessories such as privacy screen 70, work surface 22 is provided with several semicircular apertures 36 positioned directly above collar 49. FIG. 11 shows a plan view of one semicircular aperture 36.

When an accessory is not in place within semicircular aperture 36, semicircular aperture 36 is provided with operculum 72. Operculum 72 has two grommets 74. Grommets 74 allow for cabling to be threaded through semicircular aperture 36. As shown in FIG. 12, cabling would extend through operculum 72 and semicircular aperture 36 and through enclosure 34 to the floor. The cabling could then be connected to a utility outlet. Work surface 22 would thus be kept free from excessive cable clutter.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. A casegood comprising:
a vertical wall, the vertical wall having a top and a side, the top having a height;
a work surface mounted to the top; and
a height adjustment mechanism attached to the side for adjusting the height of the top, the height adjustment mechanism attached to the side.

2. The casegood of claim 1 where the height can be adjusted more than two inches.

3. The casegood of claim 2 further comprising a plurality of drawers attached to the vertical wall.

4. The casegood of claim 3 further comprising a removable enclosure surrounding a portion of the height adjustment mechanism.

5. The casegood of claim 4 where the height adjustment mechanism comprises a leg.

6. The casegood of claim 5 where the leg has a threaded portion.

7. The casegood of claim 6 where the height adjustment mechanism operates by rotation of the leg.

8. The casegood of claim 7 where the height adjustment mechanism includes an internally threaded cylinder attached to the side.

9. The casegood of claim 8 where the height adjustment mechanism includes a bracket, the bracket attached to the side.

10. The casegood of claim 9 where the height adjustment mechanism includes an internally threaded cylinder attached to the bracket.

11. The casegood of claim 10 where the height adjustment mechanism where the threaded portion is screwed through the internally threaded cylinder.

12. The casegood of claim 11 where the removable enclosure has a removable enclosure top, and the work surface covers the removable enclosure top.

13. The casegood of claim 12 where the work surface has an aperture located directly above the removable enclosure top.

14. The casegood of claim 13 where the bracket has a collar located above the height adjustment mechanism.

15. The casegood of claim 14 where the aperture is located directly above the collar such that a stanchion could extend through the aperture and engage the collar.

16. The casegood of claim 15 where the aperture has a operculum.

17. The casegood of claim 16 where the operculum has a grommet.

18. The casegood of claim 17 where the operculum has a plurality of grommets.

19. A desk comprising:
a plurality of vertical walls, the vertical walls having a top;
a work surface attached to the top; and
a plurality of height adjustment mechanisms where a height adjustment mechanism is attached to each vertical wall, the height adjustment mechanisms for raising and lowering the top.

20. The desk of claim 19 where each of the vertical walls has a side, and each height adjustment mechanism is attached to a side.

21. The desk of claim 20 where the side is exterior to the desk.

22. The desk of claim 21 where top has a height, and the height can be adjusted more than about two inches.

23. The desk of claim 22 further comprising a plurality of drawers attached to at least one side.

24. The desk of claim 23 further comprising a plurality of removable enclosures surrounding each of the height adjustment mechanisms.

25. The desk of claim 24 where each of the height adjustment mechanisms includes a leg.

26. The desk of claim 25 where the leg has a threaded portion.

27. The desk of claim 26 where each of the height adjustment mechanisms operates by rotation of the leg.

28. The desk of claim 27 where each height adjustment mechanism includes an internally threaded cylinder attached to the vertical sidewall.

29. The desk of claim 28 where each height adjustment mechanism includes a bracket, the bracket attached to the wall.

30. The desk of claim 29 where each height adjustment mechanism includes an internally threaded cylinder attached to the bracket.

31. The desk of claim 30 where the threaded portion is screwed through the internally threaded cylinder.

32. The desk of claim 31 where each of the removable enclosures has a removable enclosure top, and the work surface covers all of the removable enclosure tops.

33. The desk of claim 32 where the work surface has a plurality of apertures, each aperture located directly above the removable enclosure top.

34. The desk of claim 33 where each bracket has a collar.

35. The desk of claim 34 where each aperture is located directly above the respective collar such that a stanchion could extend through the aperture and engage the collar.

36. The desk of claim 35 where each aperture has a operculum.

37. The desk of claim 36 where each where the operculum has a grommet.

38. The desk of claim 37 where the operculum has a plurality of grommets.

39. A height adjustment mechanism for a casegood, the casegood having at least one vertical wall, comprising:
a bracket having a length greater than its width, the bracket to be attached to the desk such that the length of the bracket extends vertically; and
a moveable leg attached to the bracket, so that the leg moves longitudinally.

40. The height adjustment mechanism of claim 39 further comprising an internally threaded cylinder attached to the bracket.

41. The height adjustment mechanism of claim 40 where the leg has a threaded portion, the threaded portion screwed through the internally threaded cylinder.

42. The height adjustment mechanism of claim 41 where the bracket has a bottom, and the leg when screwed into the internally threaded cylinder extends past the bottom.

43. The height adjustment mechanism of claim 42 where the bracket has a top, includes a collar, and the collar is located near the top.

44. A height adjustable casegood comprising:
a work surface having a top and a bottom;
a frame supporting the work surface, the frame having a top and a bottom;
a first height adjustment mechanism located near the bottom of the frame for raising the frame; and
a second height adjustment mechanism located near the top of the frame for raising the work surface relative to the frame.

45. The height adjustable casegood of claim 44 where the first height adjustment mechanism is partially enclosed within the frame.

46. The height adjustable casegood of claim 45 where the second height adjustment mechanism is partially enclosed within the frame.

47. The height adjustable casegood of claim 46 where a handle is attached to the work surface for actuating the second height adjustment mechanism to allow adjustment of the height of the work surface.

48. The height adjustable casegood of claim 47 where the second height adjustment mechanism is a torsion device.

49. A work station comprising:
a first work unit, the first work unit being either a desk or a casegood, having a first work surface;
a second work unit, the second work unit being either a desk or a casegood, having a second work surface; and
a return having a return surface, said return connected to and between the first work unit and the second work unit, the return surface being vertically adjustable between a lowered position in which the return surface is generally aligned with either the first work surface or the second work surface and a raised position in which the return surface is substantially above the first work surface and the second work surface.

50. The work station of claim 49 wherein said return surface is horizontally spaced from the first work surface and the second work surface when the return surface is in the lowered position.

51. The work station of claim 50 where the return surface is horizontally spaced from the first work surface and the second work surface by more than about one-half inch.

52. A sit-to-stand desk comprising:
a sit-to-stand work surface;
attachment means for attaching the sit-to-stand desk to a casegood;
a work surface height adjustment mechanism for moving the work surface between a first lower position and a second higher position; and
a sit-to-stand desk height adjustment mechanism for adjusting the height of the first lower position relative to a floor.

53. The sit-to-stand desk of claim 52 further comprising a support attached to the sit-to-stand work surface.

54. The sit-to-stand desk of claim 53 where the attachment means are integral with the support.

55. The sit-to-stand desk of claim 54 where the work surface height adjustment mechanism is located at a first end of the support and the sit-to-stand desk height adjustment mechanism is located at a second end of the support.

56. The sit-to-stand desk of claim 55 where the sit-to-stand desk height adjustment mechanism telescopes within the support.

57. The sit-to-stand desk of claim 56 where the work surface height adjustment mechanism is a torsion mechanism.

58. The sit-to-stand desk of claim 56 where the work surface height adjustment mechanism includes a crank.

59. The sit-to-stand desk of claim 58 where the work surface height adjustment mechanism includes an electric motor.
